(19) United States
(12) Patent Application Publication
(10) Pub. No.: US 2024/0081198 A1
(43) Pub. Date: Mar. 14, 2024

(54) USE OF SILICATES IN A GREENHOUSE FILM FOR INCREASING FLOWER DEVELOPMENT OF PLANTS

(71) Applicant: Solvay SA, Brussels (BE)

(72) Inventors: Morgane Pellerin, Creil (FR); Denis Belekian, Lyon (FR); Franck Aurissergues, Argenteuil (FR); Lauriane D'Alencon, Issy-Les-Moulineaux (FR); Thierry Le Mercier, Rosny-Sous-Bois (FR)

(73) Assignee: Solvay SA, Brussels (BE)

(21) Appl. No.: 17/768,193

(22) PCT Filed: Oct. 12, 2020
(86) PCT No.: PCT/EP2020/078663

§ 371 Date: Apr. 11, 2022

(30) Foreign Application Priority Data
Oct. 11, 2019 (EP) 19306337.7

(51) Int. Cl. A01G 9/14; A01G 9/02; A01N 3/02; A01N 25/34; A01N 59/16; C09K 11/02; C09K 11/77

(52) U.S. Cl. CPC A01G 9/1438; A01G 9/02; A01N 3/02; A01N 25/34; A01N 59/16; C09K 11/02; C09K 11/77342

(57) ABSTRACT

The present invention relates to the use of silicates in a greenhouse film for increasing the flower development of a plant, wherein the film comprises at least a matrix and a silicate. Said invention also refers to a film comprising at least a matrix and said silicate to increase the flower development of a plant, and the use of a film comprising at least a matrix and said silicate in a greenhouse to increase the flower development of a plant.

The present invention relates to the use of silicates in a greenhouse film for increasing the flower development of a plant, wherein the film comprises at least a matrix and a silicate. Said invention also refers to a film comprising at least a matrix and said silicate to increase the flower development of a plant, and the use of a film comprising at least a matrix and said silicate in a greenhouse to increase the flower development of a plant.

### PRIOR ART

Flowers have long been admired and used by humans to bring beauty to their environment, and also as objects of romance, ritual, religion, medicine and as a source of food. There are furthermore several commercial values and many uses and applications which arise from the natural products that are extracted from flowers.

Flower formation is quite complex and specific and can be thought of as a series of distinct developmental steps, i.e. floral induction, the formation of flower primordia and the production of flower organs. There are three physiological developments that must occur in order for this to take place: firstly, the plant must pass from sexual immaturity into a sexually mature state (i.e. a transition towards flowering); secondly, the transformation of the apical meristem's function from a vegetative meristem into a floral meristem or inflorescence; and finally the growth of the flower's individual organs. The latter phase has been modelled using the ABC model, which describes the biological basis of the process from the perspective of molecular and developmental genetics. Mutations disrupting each of the steps have been isolated in a variety of species, suggesting that a genetic hierarchy directs the flowering process (see for review, Weigel and Meyerowitz, In Molecular Basis of Morphogenesis (ed. M. Bemfield). 51st Annual Symposium of the Society for Developmental Biology, pp. 93-107, New York, 1993).

Flowering development is then considered as very specific and is not linked to the plant growth, usually defined as promoting, increasing or improving the rate of growth of the plant or increasing or promoting an increase in the size of the plant. Indeed beyond its biomass increase there is also a need to ensure a proper development of flowers; i.e. number of flowers produced by the plants, their sizes and/or quality.

Flowering development is usually obtained by using agrochemical compositions, genetically modified organisms or specific varieties.

Such agrochemical compositions should be efficient in terms of promoting plant growth and increasing crop yields. There is therefore a general desire to obtain a high plant productivity. To improve said productivity, organic products have been used quite heavily to increase crop productivity but concerns have been raised about the long-term effects of these products on mammals, especially on humans. There is a therefore also a need for improving the productivity of crops with the help of a product without any concerns about the long-term effects of said product. The use of genetically modified organisms or specific varieties to reach a proper increased flowering development is complex and cannot be adapted to a broad range of plants and varieties.

It exists then a need to increase development of flowers in a simple manner that may be used for various types of plants.

### INVENTION

The present invention aims at solving this technical problem and non-addressed issues. Indeed, it appears that an agrochemical composition not in direct contact with the plants and having a radiation-induced emission efficiency exhibits excellent results in development of flowers, such as the number of flowers produced by the plants, their sizes and/or quality. Then it appear that now it is possible to set a plant treatment permitting to increase the development of flowers without chemicals to affect the natural plant hormones and without any concerns about the long-term effects of said products.

The present invention provides then a treatment of plants which is very effective in terms of increasing the flower development, and which leads to improved crop yields. Furthermore, the treatment used in the present invention has excellent physicochemical properties and in particular an improved stability on storage. The inorganic nature of the particles has also less impact on environment, in particular reduced long-term effects on mammals, especially on humans.

The rose and flower industry is estimated to be worth over $5 to $6 billion dollars (US) in North America at the grower level. The industry normally requires some 11-14 weeks turnaround time from cuttings to market shipment. The ability to produce a higher quality product with a reduction in some 10-20 days to market, as the technology in this invention provides, is a significant cost benefit to the flower/horticultural industry.

The present invention then concerns the use of a silicate S1 in a greenhouse film for increasing the flower development of a plant, wherein the film comprises at least a matrix and a silicate S1, preferably dispersed particles of silicate S1 in the matrix, said silicate S1 exhibiting:
(a) a light emission with a first peak wavelength in the range from 400 nm to 500 nm, preferably from 420 nm to 455 nm, and a second peak wavelength in the range from 550 nm to 700 nm, preferably from 590 nm to 660 nm, and
(b) an absorption inferior or equal to 20%, preferably inferior or equal to 15%, more preferably inferior or equal to 10%, possibly inferior or equal to 5%, at a wavelength greater than 440 nm.

The invention also refers to a film comprising at least a matrix and said silicate S1 to increase the flower development of a plant, and the use of a film comprising at least a matrix and said silicate S1 in a greenhouse to increase the flower development of a plant. Such a film and thus the silicate S1 are advantageously used in the manufacture or construction of greenhouses (greenhouse roofs, walls).

It appears that the silicates of the invention permits to the film to convert a solar or artificial radiation, preferably UV radiation, into blue and/or red light especially, or alternatively to convert solar or artificial radiation, preferably UV radiation, and especially solar UV radiation, into lower-energy radiation, allowing then an improvement in the flower development.

### DETAILED INVENTION

### Definitions

While the following terms are believed to be understood by one of ordinary skill in the art, the following definitions are set forth to facilitate explanation of the presently disclosed subject matter. Unless defined otherwise, all technical and scientific terms used herein have the same meaning as commonly understood by one of ordinary skill in the art to which the presently disclosed subject matter pertains. Although any methods, devices, and materials similar or equivalent to those described herein can be used in the practice or testing of the presently disclosed subject matter, representative methods, device, and materials are now described.

Should the disclosure of any patents, patent applications, and publications which are incorporated herein by reference conflict with the description of the present application to the extent that it may render a term unclear, the present description shall take precedence.

Throughout this specification, unless the context requires otherwise, the word “comprise” or “include”, or variations such as “comprises”, “comprising”, “includes”, including” will be understood to imply the inclusion of a stated element or method step or group of elements or method steps, but not the exclusion of any other element or method step or group of elements or method steps. According to preferred embodiments, the word “comprise” and “include”, and their variations mean “consist exclusively of”.

As used in this specification, the singular forms “a”, “an” and “the” include plural aspects unless the context clearly dictates otherwise. The term “and/or” includes the meanings “and”, “or” and also all the other possible combinations of the elements connected to this term.

The term “between” should be understood as being inclusive of the limits.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a temperature range of about 120° C. to about 150° C. should be interpreted to include not only the explicitly recited limits of about 120° C. to about 150° C., but also to include sub-ranges, such as 125° C. to 145° C., 130° C. to 150° C., and so forth, as well as individual amounts, including fractional amounts, within the specified ranges, such as 122.2° C., 140.6° C., and 141.3° C., for example.

The term “aryl” refers to an aromatic carbocyclic group of 6 to 18 carbon atoms having a single ring (e.g. phenyl) or multiple rings (e.g. biphenyl), or multiple condensed (fused) rings (e.g. naphthyl or anthranyl). Aryl groups may also be fused or bridged with alicyclic or heterocyclic rings that are not aromatic so as to form a polycycle, such as tetralin. The term “aryl” embraces aromatic radicals such as phenyl, naphthyl, tetrahydronaphthyl, indane and biphenyl. An “arylene” group is a divalent analog of an aryl group.

The term “heteroaryl” refers to an aromatic cyclic group having 3 to 10 carbon atoms and having heteroatoms selected from oxygen, nitrogen and sulfur within at least one ring (if there is more than one ring).

The term “aliphatics” refers to substituted or unsubstituted saturated alkyl chain having from 1 to 18 carbon atoms, substituted or unsubstituted alkenyl chain having from 1 to 18 carbon atoms, substituted or unsubstituted alkynyl chain having from 1 to 18 carbon atoms.

As used herein, “alkyl” groups include saturated hydrocarbons having one or more carbon atoms, including straight-chain alkyl groups, such as methyl, ethyl, propyl, butyl, pentyl, hexyl, heptyl, octyl, nonyl, decyl, cyclic alkyl groups (or “cycloalkyl” or “alicyclic” or “carbocyclic” groups), such as cyclopropyl, cyclopentyl, cyclohexyl, cycloheptyl, and cyclooctyl, branched-chain alkyl groups, such as isopropyl, tert-butyl, sec-butyl, and isobutyl, and alkyl-substituted alkyl groups, such as alkyl-substituted cycloalkyl groups and cycloalkyl-substituted alkyl groups. The term “aliphatic group” includes organic moieties characterized by straight or branched-chains, typically having between 1 and 18 carbon atoms. In complex structures, the chains may be branched, bridged, or cross-linked. Aliphatic groups include alkyl groups, alkenyl groups, and alkynyl groups.

As used herein, “alkenyl” or “alkenyl group” refers to an aliphatic hydrocarbon radical which can be straight or branched, containing at least one carbon-carbon double bond. Examples of alkenyl groups include, but are not limited to, ethenyl, propenyl, n-butenyl, i-butenyl, 3-methylbut-2-enyl, n-pentenyl, heptenyl, octenyl, decenyl, and the like. The term “alkynyl” refers to straight or branched chain hydrocarbon groups having at least one triple carbon to carbon bond, such as ethynyl.

The term “arylaliphatics” refers to an aryl group covalently linked to an aliphatics, where aryl and aliphatics are defined herein.

The term “cycloaliphatics” refers to carbocyclic groups of from 3 to 20 carbon atoms having a single cyclic ring or multiple condensed rings which may be partially unsaturated, where aryl and aliphatics are defined herein. The term “heterocyclic group” includes closed ring structures analogous to carbocyclic groups in which one or more of the carbon atoms in the ring is an element other than carbon, for example, nitrogen, sulfur, or oxygen. Heterocyclic groups may be saturated or unsaturated.

The term “alkoxy” refers to linear or branched oxy-containing groups each having alkyl portions of one to about twenty-four carbon atoms or, preferably, one to about twelve carbon atoms. Examples of such radicals include methoxy, ethoxy, propoxy, butoxy and tert-butoxy.

As used herein, the terminology “(Cn-Cm)” in reference to an organic group, wherein n and in are each integers, indicates that the group may contain from n carbon atoms to in carbon atoms per group.

The term “plant” as used herein refers to a member of the Plantae Kingdom and includes all stages of the plant life cycle, including without limitation, seeds, and includes all plant parts. Plants according to the present invention may be agricultural and horticultural plants, shrubs, trees and grasses, hereinafter sometimes collectively referred to as plants.

The term “biomass” means the total mass or weight (fresh or dry), at a given time, of a plant tissue, plant tissues, an entire plant, or population of plants. Biomass is usually given as weight per unit area. Increased biomass includes without limitation increased pod biomass, stein biomass, and root biomass.

A flower, sometimes known as a bloom or blossom, is the reproductive structure found in flowering plants (plants of the division Magnoliophyta, also called angiosperms), typically with a gynoecium, androecium, perianth and an axis. The biological function of a flower is to effect reproduction, usually by providing a mechanism for the union of sperm with eggs. Flowers may facilitate outcrossing (fusion of sperm and eggs from different individuals in a population) or allow selfing (fusion of sperm and egg from the same flower). Some flowers produce diaspores without fertilization (parthenocarpy). Flowers contain sporangia and are the site where gametophytes develop. Specific terminology is used to describe flowers and their parts. Many flower parts are fused together; fused parts originating from the same whorl are connate, while fused parts originating from different whorls are adnate; parts that are not fused are free. In those that have more than one flower on an axis, the collective cluster of flowers is termed an inflorescence. Some inflorescences are composed of many small flowers arranged in a formation that resembles a single flower.

The term “Flower development” refers to development and growth of flowers in a plant, such as notably the time in which plants flower, flowering production, accelerating the onset of flowering and flowering time; ie. the time at which floral meristem tissue is first visually detectable in the plant, for example by light microscopy or using the naked eye. Flower development is also the process by which angiosperms produce a pattern of gene expression in meristems that leads to the appearance of an organ oriented towards sexual reproduction, the flower.

The term “floral meristem” refers to a meristem in which the differentiation process produces a cell type which develops into an inflorescence meristem, a secondary inflorescence meristem, a floral organ or sexual reproductive organ, in which the meristem or organ, when developed, may comprise both reproductive and non-reproductive tissues, including, but not limited to, anthers, stamens, stigmas, ovules, carpels, petals and sepals.

The term “film” can be used in a generic sense to include film or sheet, a structural element having a geometric configuration as a three-dimensional solid whose thickness (the distance between the plane faces) is small when compared with other characteristic dimensions (in particular length, width) of the film. Films are generally used to separate areas or volumes, to hold items, to act as barriers, or as printable surfaces.

The term “greenhouse” should be understood herein in its broadest sense as covering any type of shelter used for the protection and growth of crops. For example, they may be plastic greenhouses and large plastic tunnels, glass greenhouses, large shelters, semi-forcing tunnels, flat protective sheets, walls, mulching (mulch film), notably as described in the brochure published by the CIPA (Congrès International du Plastique dans I′Agriculture), 65 rue de Prony, Paris, “L′évolution de la plasticulture dans le Monde” by Jean-Pierre Jouët. Greenhouse may also refer to gardening kit and kit of germination.

The term “emission” corresponds to the photons emitted by a luminescent material under an excitation wavelength matching the excitation spectrum of the luminescent material.

The term “peak wavelength” means publicly recognized meaning, in this specification which can comprise both the main peak of an emission/absorption (preferably emission) spectrum having maximum intensity/absorption and side peaks having smaller intensity/absorption than the main peak. The term peak wavelength can be related to a side peak. The term peak wavelength can be related to the main peak having maximum intensity/absorption.

The term “radiation-induced emission efficiency” should also be understood in this connection, i.e. the silicate absorbs radiation in a certain wavelength range and emits radiation in another wavelength range with a certain efficiency.

Plants

Plants included in the invention are any flowering plants, including both monocotyledonous and dicotyledonous plants. Examples of monocotyledonous plants include, but are not limited to, vegetables such as asparagus, onions and garlic; cereals such as maize, barley, wheat, rice, sorghum, pearl millet, rye and oats; and grasses such as forage grasses and turfgrasses. Examples of dicotyledonous plants include, but are not limited to, vegetables, feed, and oil crops such as tomato, beans, soybeans, peppers, lettuce, peas, alfalfa, clover, Brassica species (e.g., cabbage, broccoli, cauliflower, brussel sprouts, rapeseed, and radish), carrot, beets, eggplant, spinach, cucumber, squash, melons, cantaloupe, sunflowers; fiber crops such as cotton; and various ornamentals such as flowers and shrubs. Plants used for the invention may be planted for the production of an agricultural or horticultural product, for example grain, food, fiber, etc. The plant may be a cereal plant.

The films and uses of the present invention may be applied to virtually any variety of plants. The plants may be selected from, but not limited to, the following list:
food crops: such as cereals including maize/corn (Zea mays), sorghum (Sorghum spp.), millet (Panicum miliaceum, P. sumatrense), rice (Oryza sativa indica, Oryza sativa japonica), wheat (Triticum sativa), barley (Hordeum vulgare), rye (Secale cereale), triticale (Triticum X Secale), and oats (Avena fatua);
leafy vegetables: such as brassicaceous plants such as cabbages, broccoli, bok choy, rocket; salad greens such as spinach, cress, basil, and lettuce;
fruiting and flowering vegetables: such as avocado, sweet corn, artichokes, curcubits e.g. squash, cucumbers, melons, watermelons, squashes, such as courgettes, pumpkins; solononaceous vegetables/fruits e.g. tomatoes, eggplant, and capsicums;
podded vegetables: such as groundnuts, peas, beans, lentils, chickpea, and okra;
bulbed and stein vegetables: such as asparagus, celery, allium crops e.g garlic, onions, and leeks;
roots and tuberous vegetables: such as carrots, beet, bamboo shoots, cassava, yams, ginger, Jerusalem artichoke, parsnips, radishes, potatoes, sweet potatoes, taro, turnip, and wasabi;
sugar crops: such as sugar beet (Beta vulgaris) and sugar cane (Saccharum officinarum);
crops grown for the production of non-alcoholic beverages and stimulants: such as coffee, black, herbal and green teas, cocoa, and tobacco;
fruit crops: such as true berry fruits (e.g. kiwifruit, grape, currants, gooseberry, guava, feijoa, pomegranate), citrus fruits (e.g. oranges, lemons, limes, grapefruit), epigynous fruits (e.g. bananas, cranberries, blueberries), aggregate fruit (blackberry, raspberry, boysenberry), multiple fruits (e.g. pineapple, fig), stone fruit crops (e.g. apricot, peach, cherry, plum), pip-fruit (e.g. apples, pears) and others such as strawberries, and sunflower seeds;
culinary and medicinal herbs: such as. rosemary, basil, bay laurel, coriander, mint, dill, Hypericum, foxglove, alovera, and rosehips;
crop plants producing spices: such as black pepper, cumin, cinnamon, nutmeg, ginger, cloves, saffron, cardamom, mace, paprika, masalas, and star anise;
crops grown for the production of nuts and oils: such as. almonds and walnuts, Brazil nut, cashew nuts, coconuts, chestnut, macadamia nut, pistachio nuts; peanuts, pecan nuts, soybean, cotton, olives, sunflower, sesame, lupin species and brassicaeous crops (e.g. canola/oilseed rape);
crops grown for production of beers, wines and other alcoholic beverages e.g grapes, hops;
plants used in pastoral agriculture: such as legumes: Trifolium species, Medicago species, and Lotus species; White clover (T. repens); Red clover (T. pratense); Caucasian clover (T. ambigum); subterranean clover (T. subterraneum); Alfalfa/Lucerne (Medicago sativum); annual medics; barrel medic; black medic; Sainfoin (Onobrychis viciifolia); Birdsfoot trefoil (Lotus comiculatus); Greater Birdsfoot trefoil (Lotus pedunculatus);
forage and amenity grasses: such as temperate grasses such as Lolium species; Festuca species; Agrostis spp., Perennial ryegrass (Lolium perenne); hybrid ryegrass (Lolium hybridum); annual ryegrass (Lolium multiflorum), tall fescue (Festuca arundinacea); meadow fescue (Festuca pratensis); red fescue (Festuca rubra); Festuca ovina; Festuloliums (Lolium X Festuca crosses); Cocksfoot (Dactylis glomerata); Kentucky bluegrass Poa pratensis; Poa palustris; Poa nemoralis; Poa trivialis; Poa compresa; Bromus species; Phalaris (Phleum species); Arrhenatherum elatius; Agropyron species; Avena strigosa; and Setaria italic;
tropical grasses such as: Phalaris species; Brachiaria species; Eragrostis species; Panicum species; Bahai grass (Paspalum notatum); Brachypodium species;
grasses used for biofuel production: such as Switchgrass (Panicum virgatum) and Miscanthus species;
fiber frops: such as hemp, jute, coconut, sisal, flax (Linum spp.), New Zealand flax (Phormium spp.); plantation and natural forest species harvested for paper and engineered wood fiber products such as coniferous and broadleafed forest species;
tree and shrub species used in plantation forestry and bio fuel crops: such as Pine (Pinus species); Fir (Pseudotsuga species); Spruce (Picea species); Cypress (Cupressus species); Wattle (Acacia species); Alder (Alnus species); Oak species (Quercus species); Redwood (Sequoiadendron species); willow (Salix species); birch (Betula species); Cedar (Cedurus species); Ash (Fraxinus species); Larch (Larix species); Eucalyptus species; Bamboo (Bambuseae species) and Poplars (Populus species);
plants grown for conversion to energy, biofuels or industrial products by extractive, biological, physical or biochemical treatment: such as oil-producing plants such as oil palm, jatropha, and linseed;
latex-producing plants: such as the Para Rubber tree, Hevea brasiliensis and the Panama Rubber Tree Castilla elastica;
plants used as direct or indirect feedstocks for the production of biofuels i.e. after chemical, physical (e.g. thermal or catalytic) or biochemical (e.g. enzymatic pre-treatment) or biological (e.g. microbial fermentation) transformation during the production of biofuels, industrial solvents or chemical products e.g. ethanol or butanol, propane diols, or other fuel or industrial material including sugar crops (e.g. beet, sugar cane), starch-producing crops (e.g. C3 and C4 cereal crops and tuberous crops), cellulosic crops such as forest trees (e.g. Pines, Eucalypts) and Graminaceous and Poaceous plants such as bamboo, switch grass, miscanthus;
crops used in energy, biofuel or industrial chemical production by gasification and/or microbial or catalytic conversion of the gas to biofuels or other industrial raw materials such as solvents or plastics, with or without the production of biochar (e.g. biomass crops such as coniferous, eucalypt, tropical or broadleaf forest trees, graminaceous and poaceous crops such as bamboo, switch grass, miscanthus, sugar cane, or hemp or softwoods such as poplars, willows;
biomass crops used in the production of biochar;
crops producing natural products useful for the pharmaceutical, agricultural nutraceutical and cosmeceutical industries: such as crops producing pharmaceutical precursors or compounds or nutraceutical and cosmeceutical compounds and materials for example, star anise (shikimic acid), Japanese knotweed (resveratrol), kiwifruit (soluble fiber, proteolytic enzymes);
floricultural, ornamental and amenity plants grown for their aesthetic or environmental properties: such as flowers such as roses, tulips, chrysanthemums;
ornamental shrubs such as Buxus, Hebe, Rosa, Rhododendron, and Hedera;
amenity plants such as Platanus, Choisya, Escallonia, Euphorbia, and Carex; and
plants grown for bioremediation: Helianthus, Brassica, Salix, Populus, and Eucalyptus.

Plant species includes but not limited to corn (Zea mays), Brassica sp. (e.g., B. napus, B. rapa, B. juncea), alfalfa (Medicago sativa), rice (Oryza sativa), rye (Secale cereale), sorghum (Sorghum bicolor, Sorghum vulgare), millet (e.g., pearl millet (Pennisetum glaucum), proso millet (Panicum miliaceum), foxtail millet (Setaria italica), finger millet (Eleusine coracana)), sunflower (Helianthus annuus), safflower (Carthamus tinctorius), wheat (Triticum aestivum), soybean (Glycine max), tobacco (Nicotiana tabacum), potato (Solanum tuberosum), peanuts (Arachis hypogaea), cotton (Gossypium barbadense, Gossypium hirsutum), sweet potato (Ipomoea batatus), cassava (Manihot esculenta), coffee (Cofea spp.), coconut (Cocos nucifera), pineapple (Ananas comosus), citrus trees (Citrus spp.), cocoa (Theobroma cacao), tea (Camellia sinensis), banana (Musa spp.), avocado (Persea americana), fig (Ficus casica), guava (Psidium guajava), mango (Mangifera indica), olive (Olea europaea), papaya (Carica papaya), cashew (Anacardium occidentale), macadamia (Macadamia integrifolia), almond (Prunus amygdalus), sugar beets (Beta vulgaris), sugarcane (Saccharum spp.), tomatoes (Solanum lycopersicum), lettuce (e.g., Lactuca sativa), green beans (Phaseolus vulgaris), lima beans (Phaseolus limensis), peas (Lathyrus spp.), cauliflower (Brassica oleracea), broccoli (Brassica oleracea), turnip (Brassica rapa var. rapa), radish (Raphanus raphanistrum subsp. Sativus), spinach (Spinacia oleracea), cabbage (Brassica oleracea), asparagus (Asparagus officinalis), onion (Allium cepa), garlic (Allium sativum), pepper (Piperaceae), such as Piper nigrum, Piper cubeba, Piper longum, Piper retrofractum, Piper borbonense, and Piper guineense, celery (Apium graveolens), members of the genus Cucumis such as cucumber (Cucumis sativus), cantaloupe (Cucumis cantalupensis), and musk melon (Cucumis melo), oats (Avena sativa), barley (Hordeum vulgare), plants of Cucurbitaceae family such as squash (Cucurbita pepo), pumpkin (Cucurbita maxima) and zucchini (Cucurbita pepo), apple (Malus domestica), pear (Pyrus spp.), quince (Cydonia oblonga), plum (Prunus subg. Prunus), peach (Prunus persica), cherry (such as Prunus avium and Prunus cerasus), nectarine (Prunus persica var. nucipersica), apricot (such as Prunus armeniaca, Prunus brigantina, Prunus mandshurica, Prunus mume, Prunus zhengheensis and Prunus sibirica), strawberry (Fragaria×ananassa), grape (Vitis vinifera), raspberry (plant genus Rubus), blackberry (Rubus ursinus, Rubus laciniatus, Rubus argutus, Rubus armeniacus, Rubus plicatus, Rubus ulmifolius, and Rubus allegheniensis), sorghum (Sorghum bicolor), rapeseed (Brassica napus), clover (Syzygium aromaticum), carrot (Daucus carota), lentils (Lens culinaris), and thale cress (Arabidopsis thaliana).

Mention can further be made of ornamentals species including but not limited to hydrangea (Macrophylla hydrangea), hibiscus (Hibiscus rosasanensis), petunias (Petunia hybrida), roses (Rosa spp.), azalea (Rhododendron spp.), tulips (Tulipa spp.), daffodils (Narcissus spp.), carnation (Dianthus caryophyllus), poinsettia (Euphorbia pulcherrima), and chrysanthemum (Chrysanthemum indicum); and of conifer species including but not limited to conifers pines such as loblolly pine (Pinus taeda), slash pine (Pinus elliotii), ponderosa pine (Pinus ponderosa), lodgepole pine (Pinus contorta), and Monterey pine (Pinus radiata), Douglas-fir (Pseudotsuga menziesii); Western hemlock (Tsuga canadensis); Sitka spruce (Picea glauca); redwood (Sequoia sempervirens); true firs such as silver fir (Abies amabilis) and balsam fir (Abies balsamea); and cedars such as Western red cedar (Thuja plicata) and Alaska yellow-cedar (Chamaecyparis nootkatensis).

Preferably, plants are chosen in the group constituted of: tomatoes (Solanum lycopersicum), watermelon (Cucurbitaceae lanatus), pepper, zucchini, cucumber, melon, strawberries, blueberries, raspberries and roses. They are tomatoes for instance.

Specifically, tomatoes classes of interest can be chosen in the group constituted of: long life, grooved, cluster, smooth or salad tomato, cherry and roma tomatoes. Some varieties example may include Alicante, Trujillo, Genio, Cocktail, Beefsteak, Marmande, Conquista, Kumato, Adoration, Better Boy, Big Raimbow, Black Krim, Brandwyne, Campari, Canario, Tomkin, Early Girl, Garden peach, Hanover, Jersey Boy, Jubilee, Matt's Wild Cherry, Micro Tom, Montesora, Mortgage Lifter, Plum Tomato, Raf Tomato, Delizia, Roma, San Marzano, Santorini, Super Sweet 10, Tomaccio, Pear Tomato, and Yellow Pear.

Silicate

Silicate S1 exhibits according to the invention:
(a) a light emission with a first peak wavelength in the range from 400 nm to 500 nm, preferably from 420 nm to 455 nm, and a second peak wavelength in the range from 550 nm to 700 nm, preferably from 590 nm to 660 nm, and
(b) an absorption inferior or equal to 15%, preferably inferior or equal to 10%, more preferably inferior or equal to 5%, at a wavelength greater than 440 nm.

Light emission spectrum may be obtained using a Jobin Yvon HORIBA Fluoromax-4+ equipped with a Xenon lamp and 2 monochromators (one for excitation wavelength and one for emission wavelength). The excitation wavelength is fixed at 370 nm and the spectrum is recorded between 390 and 750 nm.

The absorption may be obtained from a diffuse reflection spectrum. Such a spectrum can be recorded using a Jobin Yvon HORIBA Fluoromax-4+ spectrometer equipped with a Xenon lamp and 2 monochromators (one for excitation wavelength and one for emission wavelength) able to work synchronously. With regard to a product, for each given value of wavelength, a reflection (R_{product}) value (intensity) is obtained, which in the end provides a reflection spectrum (R_{product} in function of wavelength). A first reflection (R_{white}) spectrum of BaSO₄ is recorded between 280 nm and 500 nm. BaSO₄ spectrum represents 100% of light reflection (referred to as “white”). A second reflection (R_{black}) spectrum of black carbon is recorded between 280 nm and 500 nm. Black carbon spectrum represents 0% of light reflection (referred to as “black”). The sample reflection (Rₛₐₘₚₗₑ) spectrum is recorded between 280 nm and 500 nm. For each wavelength, the following relationship is calculated: A=1−R, R being equal to (Rₛₐₘₚₗₑ−R_{black})/(R_{white}−R_{black}), i.e. A=(R_{white}−Rₛₐₘₚₗₑ)/(R_{white}−R_{black}), which represents the absorption at each wavelength and which provides the absorption spectrum (in function of wavelength).

Silicate S1 used in the invention may be compounds comprising at least barium, magnesium and silicon. Preferably, in silicate S1, the barium, and the magnesium may be substituted with at least an other element, such as for instance: europium, praseodymium and/or manganese.

Silicate S1 may be notably a compound of formula (I):

aMO·a′M′O·bM″O·b′M′″O·cSiO₂ (I)

wherein: M and M″ are selected from the group constituted of: strontium, barium, calcium, zinc, magnesium or a combination of these and M′ and M′″ are selected from the group constituted of: europium, manganese, praseodymium, gadolinium, yttrium with 0.5<a≤3, 0.5<b≤3, 0<a′≤0.5, 0<b′≤0.5 and 1≤c≤2.

Film may comprise, in addition to silicate S1, other types of silicates, such as for instance Ba₂SiO₄ (for example as traces).

Silicate S1 may notably a compound of formula (II):

aBaO·xEuO·cMgO·yMnO·eSiO₂ (II)

wherein: 0.5<a≤3, 0<x≤0.5, 0<c≤1, 0<y≤0.5, 1≤e≤2.

Preferably a+b+c+d+e is comprised from 90% to 100%, more preferably from 95% to 99%, usually superior or equal to 98 weight %.

In formula (II) preferably 0.0001≤x≤0.4 and 0.0001≤y≤0.4, more preferably 0.01≤x≤0.35 and 0.04≤y≤0.15.

In the compound of formula (II), the barium, magnesium and silicon may be partially replaced with elements other than those described above. Thus, the barium may be partially replaced with calcium and/or strontium in a proportion that may be up to about 30%, this proportion being expressed by the replacement/(replacement+barium) atomic ratio. The magnesium may be partially replaced with zinc in a proportion that may be up to about 30%, this proportion also being expressed by the Zn/(Zn+Mg) atomic ratio. Finally, the silicon may be partially replaced with germanium, aluminum and/or phosphorus in a proportion that may be up to about 10%, this proportion being expressed by the replacement/(replacement+ silicon) atomic ratio.

Whereas a europium-doped barium magnesium silicate emits in the blue range, the presence of manganese as dopant makes it possible to orient the emission of this compound toward the red range. It is possible to adjust the colorimetry of the emission of the additive of the invention by varying the Eu/Mn ratio.

In silicate S1 of formula (II) the barium, the magnesium and the silicon are preferably not substituted with an element other than europium and manganese.

Silicates S1 of formula (II) may be chosen in the group constituted of:
Ba_{2.7}Eu_{0.3}Mg_{0.9}Mn_{0.1}Si₂O₈,
Ba_{2.7}Eu_{0.3}Mg_{0.8}Mn_{0.2}Si₂O₈,
Ba_{2.94}Eu_{0.06}Mg_{0.95}Mn_{0.05}Si₂O₈,
Ba_{2.9}Eu_{0.1}Mg_{0.95}Mn_{0.05}Si₂O₈, and
BaMg₂Si₂O₇:Eu, Mn.

Silicate S1 may also correspond to a compound of formula (III):

Ba_{3(1-x-y)}Eu₃ₓPr_{3y}Mg_{1-z}Mn_{z}Si_{2(1-3v/2)}M₃ᵥO₈ (III)

wherein M represents aluminum, gallium or boron and 0<x≤0.3; 0<y≤0,1; 0<z≤0.3; 0≤v≤0,1.

The silicate S1 used for the invention is generally prepared by means of a solid-state reaction at high temperature.

As starting material, it is possible to use directly the metal oxides required or organic or mineral compounds capable of forming these oxides by heating, for instance the carbonates, oxalates, hydroxides, acetates, nitrates or borates of said metals.

An intimate mixture at the appropriate concentrations of all of the starting materials in finely divided form is formed.

It may also be envisioned to prepare a starting mixture by co-precipitation using solutions of the precursors of the desired oxides and/or slurries of oxides, for example in aqueous medium.

The mixture of the starting materials is then heated at least once for a period of between one hour and about one hundred hours, at a temperature of between about 500° C. and about 1600° C.; it is preferable to perform the heating at least partially under a reductive atmosphere, for example hydrogen in argon, to bring the europium totally into divalent form. A flux such as BaF₂, BaCl₂, NH₄Cl, Mg₂, MgCl₂, Li₂B₄O₇, LiF, H₃BO₃, may also be added to the raw material mix before the heating step.

Silicates used in the invention may notably be produced as described in WO2004/044090, WO2004/041963.

It may also be possible to produce silicates of the invention by mixing a silica suspension and starting materials, such as nitrates, followed by a spray drying and calcination, notably calcination by air and/or reduced atmosphere. Such silicates may notably be produced as described in WO2016/001219.

There is no limitation on the form, morphology, particle size or particle size distribution of the silicates thus obtained. These products may be ground, micronized, screened and surface-treated, especially with organic additives, to facilitate their compatibility or dispersion in the application medium.

The particles of silicate S1 are preferably such that the dispersion remains stable over a certain period of time.

Silicate S1 is preferably in the form of solid particles, such as crystallized particles, having a size D50 between 1 μm and 50 μm, more preferably between 2 μm and 10 μm. Silicate S1 may also be in the form of solid particles, such as crystallized particles, having a size D50 between 0.1 μm and 1.0 μm, preferably between 0.1 μm and 0.5 μm.

D50 has the usual meaning used in statistics. D50 corresponds to the median value of the distribution. It represents the particle size such that 50% of the particles are less than or equal to the said size and 50% of the particles are higher than or equal to said size. D50 is determined from a distribution of size of the particles (in volume) obtained with a laser diffraction particle size analyzer. The appliance Malvern Mastersizer 3000 may be used.

Matrix

According to the present invention, as the matrix material, a transparent photosetting polymer, a thermosetting polymer, a thermoplastic polymer, glass substrates or a combination of any of these, can be used preferably. This matrix may be a natural or non-natural fiber, such as silk, wool, cotton or hemp, or alternatively viscose, nylon, polyamides, polyester and copolymers thereof. The matrix may also be a mineral glass (silicate) or an organic glass. The matrix may also be based on a polymer especially of thermoplastic type. The matrix may comprise at least one polymer or the matrix may be a polymer.

As polymer materials, polyethylene, polypropylene, polystyrene, polymethylpentene, polybutene, butadiene styrene polymer, polyvinyl chloride, polystyrene, polymethacrylic styrene, styrene-acrylonitrile, acrylonitrile-butadiene-styrene, polyethylene terephthalate, polymethyl methacrylate, polyphenylene ether, polyacrylonitrile, polyvinyl alcohol, acrylonitrile polycarbonate, polyvinylidene chloride, polycarbonate, polyamide, polyacetal, polybutylene terephthalate, polytetrafluoroethylene, ethyl vinylacetate copolymer, ethylene butyl acrylate copolymer, ethylene tetrafluorethylen copolymer, phenol polymer, melamine polymer, urea polymer, urethane, epoxy, unsaturated polyester, polyallyl sulfone, polyarylate, hydroxybenzoic acid polyester, polyetherimide, polycyclohexylenedimethylene terephthalate, polyethylene naphthalate, polyester carbonate, polylactic acid, phenolic resin, silicone can be used preferably.

As the photosetting polymer, several kinds of (meth)acrylates can be used preferably. Such as unsubstituted alkyl-(meth)acrylates, for examples, methyl-acrylate, methyl-methacrylate, ethyl-acrylate, ethyl-methacrylate, butyl-acrylate, butyl-methacrylate, 2-ethylhexyl-acrylate, 2-ethylhexyl-methacrylate; substituted alkyl-(meth)acrylates, for examples, hydroxyl-group, epoxy group, or halogen substituted alkyl-(meth)acrylates; cyclopentenyl(meth)acrylate, tetra-hydro furfuryl-(meth)acrylate, benzyl (meth)acrylate, polyethylene-glycol di-(meth)acrylates.

The matrix material may have a Melt Flow Index in the range from 0.1 to 50 g/10 min preferably, more preferably from 0.1 to 7 g/10 min for polyethylene and from 0.7 to 4 g/min for ethyl vinylacetate copolymer; notably determined using a MFI apparatus, the sample being preheated for 5 min at 190° C., the weight used weights 2.16 kg (according to the standard method ISO1133).

As the thermosetting polymer, publically known transparent thermosetting polymer can be used preferably.

As the thermoplastic polymer, the type of thermoplastic polymer is not particularly limited. For example, natural rubber (refractive index (n)=1.52), poly-isoprene (n=1.52), poly 1,2-butadiene (n=1.50), polyisobutene (n=1.51), polybutene (n=1.51), poly-2-heptyl 1,3-butadine (n=1.50), poly-2-t-butyl-1,3-butadine (n=1.51), poly-1,3-butadine (n=1.52), polyoxyethylene (n=1.46), polyoxypropylene (n=1.45), polyvinylethyl ether (n=1.45), polyvinylhexylether (n=1.46), polyvinylbutylether (n=1.46), polyethers, poly vinyl acetate (n=1.47), poly esters, such as poly vinyl propionate (n=1.47), poly urethane (n=1.5 to 1.6), ethyl cellulose (n=1.48), poly vinyl chloride (n=1.54 to 1.55), poly acrylo nitrile (n=1.52), poly methacrylonitrile (n=1.52), poly-sulfone (n=1.63), poly sulfide (n=1.60), phenoxy resin (n=1.5 to 1.6), polyethylacrylate (n=1.47), poly butyl acrylate (n=1.47), poly-2-ethylhexyl acrylate (n=1.46), poly-t-butyl acrylate (n=1.46), poly-3-ethoxypropylacrylate (n=1.47), polyoxycarbonyl tetra-methacrylate (n=1.47), polymethylacrylate (n=1.47 to 1.48), polyisopropylmethacrylate (n=1.47), polydodecyl methacrylate (n=1.47), polytetradecyl methacrylate (n=1.47), poly-n-propyl methacrylate (n=1.48), poly-3,3,5-trimethylcyclohexyl methacrylate (n=1.48), polyethylmethacrylate (n=1.49), poly-2-nitro-2-methylpropylmethacrylate (n=1.49), poly-1,1-diethylpropylmethacrylate (n=1.49), poly(meth)acrylates, such as polymethylmethacrylate (n=1.49), or a combination of any of these, can be used preferably as desired.

As examples of thermoplastic polymers that are suitable for the invention, mention may be made of: polycarbonates, for instance poly[methanebis(4-phenyl) carbonate], poly[1,1-etherbis(4-phenyl) carbonate], poly[diphenylmethanebis(4-phenyl) carbonate], poly[1,1-cyclohexanebis(4-phenyl) carbonate] and polymers of the same family; polyamides, for instance poly(4-aminobutyric acid), poly(hexamethylene adipamide), poly(6-aminohexanoic acid), poly(m-xylylene adipamide), poly(p-xylylene sebacamide), poly(2,2,2-trimethyl hexamethylene terephthalamide), poly(meta-phenylene isophthalamide), poly(p-phenylene terephthalamide) and polymers of the same family; polyesters, for instance poly(ethylene azelate), poly(ethylene-1,5-naphthalate), poly(1,4-cyclohexanedimethylene terephthalate), poly(ethylene oxybenzoate), poly(para-hydroxybenzoate), poly(1,4-cyclohexylidene dimethylene terephthalate), poly(1,4-cyclohexylidene dimethylene terephthalate), polyethylene terephthalate, polybutylene terephthalate and polymers of the same family; vinyl polymers and copolymers thereof, for instance polyvinyl acetate, polyvinyl alcohol, polyvinyl chloride; polyvinyl butyral, polyvinylidene chloride, ethylene-vinyl acetate copolymers, and polymers of the same family; acrylic-polymers, polyacrylates and copolymers thereof, for instance polyethyl acrylate, poly(n-butyl acrylate), polymethyl methacrylate, polyethyl methacrylate, poly(n-butyl methacrylate), poly(n-propyl methacrylate), and ethylene butyl acrylate copolymer, polyacrylamide, polyacrylonitrile, poly(acrylic acid), ethylene-acrylic acid copolymers, ethylene-vinyl alcohol copolymers, acrylonitrile copolymers, methylstyrene methacrylate copolymers, ethylene-ethyl acrylate copolymers, methacrylate-butadiene-styrene copolymers, ABS, and polymers of the same family; polyolefins, for instance low-density poly(ethylene), poly(propylene) and in general [alpha]-olefins of ethylenes and of propylene copolymerized with other [alpha]-olefins such as 1-butene and 1-hexenes, which may be used at up to 1%. Other comonomers used may be cyclic olefins such as 1,4-hexadiene, cyclopentadiene and ethylidenenorbornene. The copolymers may also be a carboxylic acid such as acrylic acid or methacrylic acid. Finally, mention may be made of low-density chlorinated poly(ethylene), poly(4-methyl-1-pentene), poly(ethylene) and poly(styrene).

Among these thermoplastic polymers, the ones most particularly preferred are polyethylenes and copolymers, including low-density polyethylenes (LDPE), linear low-density polyethylenes (LLDPE), high-density polyethylene (HDPE)polyethylenes obtained via metallocene synthesis, ethyl vinylacetate copolymer (EVA), ethylene butyl acrylate copolymer (EBA), polyvinyl chloride (PVC), polyethylene terephthalate (PET), polymethyl methacrylate (PMMA), (co)polyolefins such as polyethylene-vinyl alcohol (EVOH), polycarbonate (PC), and mixtures and copolymers based on these (co)polymers.

Composition

Composition used in the context of the present invention comprises at least a matrix and the silicate used according to the invention. Silicates S1 may be dispersed in the matrix and the film of the invention may comprise a matrix and dispersed particles of silicates in the matrix. Preferably silicates S1 may be dispersed in the polymer and the film used in the invention may comprise a polymer and dispersed particles of silicates in the polymer.

The amount of silicate in the film may especially be from 0.01 to 10% by weight particularly from 0.1% to 5% and more particularly from 0.3 to 3% by weight, with respect to the total amount of film. Preferably this amount is equal to 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9 and 2, and any ranges made by these values.

The composition can optionally further comprise one or more of additional inorganic fluorescent materials, notably which emits blue or red light. As an additional inorganic fluorescent material which emits blue or red light, any type of publically known materials, for example as described in the second chapter of Phosphor handbook (Yen, Shinoya, Yamamoto), can be used if desired.

The composition may also comprise other additive(s), for instance stabilizers, plasticizers, flame retardants, dyes, optical brighteners, lubricants, antiblocking agents, matting agents, processing agents, elastomers or elastomeric compositions, for example acrylic copolymers or methacrylate-butadienestyrene copolymers, for improving the flexibility or mechanical strength of the films, adhesion agents, for example polyolefins grafted with maleic anhydride allowing adhesion to polyamide, dispersants allowing better distribution of the silicate in the material or any other additive required for the preparation of a structure of multilayer thermoplastic films, especially those known and often used for making films for greenhouses, for example nondrip or anti-misting additives, or catalysts. This list is not limiting in nature.

Any method for obtaining a dispersion of the silicate in a matrix and especially in a macro-molecular compound of the type such as the above-mentioned polymers, may be used to prepare the compositions and films used according to the invention.

The incorporation of the silicate and optional further components into the polymer may be carried out by known methods such as dry blending in the form of a powder, or wet mixing in the form of solutions, dispersions or suspensions for example in an inert solvent, water or oil. The silicateand optional further additives may be incorporated, for example, before or after molding or also by applying the dissolved or dispersed additive or additive mixture to the polymer material, with or without subsequent evaporation of the solvent or the suspension/dispersion agent. They may be added directly into the processing apparatus (e.g. extruders, internal mixers), e.g. as a dry mixture or powder or as solution or dispersion or suspension or melt.

In particular, a first process consists in mixing the silicate and the other abovementioned additives in a polymer compound in melt form and optionally in subjecting the mixture to high shear, for example in a twin-screw extrusion device, in order to achieve good dispersion. Another process consists in mixing the additive(s) to be dispersed with the monomers in the polymerization medium, and then in performing the polymerization.

Another process consists in mixing with a polymer in melt form, a concentrated blend of a polymer and of dispersed additives (masterbatch), for example prepared according to one of the processes described above. Polymer for the masterbatch and polymer of the matrix may be of the same type or may also be different. The two polymers are preferably compatible so as to form an homogeneous mixture. For instance, when a polymer is an ethylene-vinyl acetate copolymer, the other polymer may be the same ethylene-vinyl acetate copolymer or a different one or may also be a compatible polymer, like for instance a polyethylene. The masterbatch is prepared by the same conventional technique described above, for instance it can be prepared with an extruder. The interest of using a masterbatch is that the particles can be well predispersed using a mixing equipment exhibiting high shear rates. The various additives (e.g. crosslinking agent(s), auxiliary agent(s) described above) may be present in any one of the polymers or may be added separately.

In a process for preparing a composition within the context of the invention, a polymer (polymer 1) and the silicate, or else a polymer (polymer 1) and a masterbatch comprising the silicate pre-dispersed in a polymer (polymer 2), are extruded.

The silicate may be introduced into the synthesis medium for the macromolecular compound, or into a thermoplastic polymer melt in any form. It may be introduced, for example, in the form of a solid powder or in the form of a dispersion in water or in an organic dispersant.

It is also possible to directly disperse the silicate compound in powder form in the matrix, for example by stirring, or alternatively in preparing a powder concentrate in liquid or pasty medium, which is then added to the matrix. The concentrate may be prepared in a water-based or solvent medium, optionally with surfactants, water-soluble or hydrophobic polymers, or alternatively polymers comprising hydrophilic and hydrophobic ends, which may be polar or nonpolar, required for stabilization of the mixture in order to avoid its decantation. There is no limit to the additives that may be included in the composition of the concentrate.

Film

Greenhouse films within the context of the present invention may be of various shapes such as for instance plates, flat sheet, square, rectangle, circle, walls, tunnel, elliptical, semicircular, shelter, protective sheets and building materials of greenhouse.

The film used according to the invention comprises at least a matrix and a silicate S1, preferably dispersed particles of silicate S1, said silicate S1 exhibiting:
(a) a light emission with a first peak wavelength in the range from 400 nm to 500 nm, preferably from 420 nm to 455 nm, and a second peak wavelength in the range from 550 nm to 700 nm, preferably from 590 nm to 660 nm, and
(b) an absorption inferior or equal to 20%, preferably inferior or equal to 15%, more preferably inferior or equal to 10%, possibly inferior or equal to 5%, at a wavelength greater than 440 nm.

The film within the context of the invention may be used as such or may be deposited on or combined with another substrate, such as another film or glass. This deposit or this combination may be prepared by the known methods of coextrusion, lamination and coating for instance. Multilayer structures may be formed from one or more layers of material used according to the invention, combined via layers of coextrusion binder to one or more other layers of one or more thermoplastic polymers, for example polyethylene or polyvinyl chloride, which may constitute a support component, which is predominant in the constitution of the film. The film thus obtained may be monoaxially or biaxially drawn, according to the known techniques for converting plastics. The sheets or plates may be cut, thermoformed or stamped in order to give them the desired shape.

The film can also be coated with the above polymers or silicone-based coatings (e.g. SiOx) or aluminum oxide or any other coating applied by plasma, web coating or electron-beam coating.

The film within the context of the invention may also be a multilayer film, having at least 2 layers formed from polymeric or other materials that are bonded together by any conventional or suitable method, including one or more of the following: coextrusion, extrusion coating, lamination, vapor deposition coating, solvent coating, emulsion coating, and/or suspension coating. At least one of the layers of the multilayer film comprises at least silicate S1.

Generally, the film is transparent and flexible.

The layer thickness of the film may be in the range from 50 μm to 1 mm, preferably from 100 μm to 800 μm, more preferably from 200 μm to 700 μm.

The film within the context of the invention may exhibit a transmission superior or equal to 80%, preferably from 85% to 98%. The transmission may be measured with a Gardner Haze-gard i (4775) Haze Meter from BYK, for instance according to the standard method ASTM D1003.

Application

The present invention also refers to a method for increasing the flower development of a plant by providing a greenhouse film according to the invention to a plant in a growing medium with a light treatment. The invention also refers to a method for increasing the flower development of a plant in which the flower development is stimulated by a light emission provided by a greenhouse film. The invention also refers to a method for increasing the flower development of a plant in which the plant is in a greenhouse comprising a greenhouse film.

The film can form the cover of a greenhouse (roof, walls), protecting the plants from the influences of the surrounding or the film can be used in the inside of a greenhouse to cover or protect the plants or a part of the plants from influences originating from inside, such as artificial watering or spraying of herbicides and/or insecticides.

The growing media are well known agronomically suitable media in which plants may be cultivated. Examples include any of various media containing agronomically suitable components (e.g., sand, soil, vermiculite, peat); agar gel; and any of various hydroponic media, such as water, glass wools or Perlite®). Water and mineral nutrients are two inputs that are essential in any horticultural or agricultural operation, and the management of the application of these substances can have a large influence on both yield and quality. There is a large variety of different ways these two substances can be applied to satisfy plant requirements. In some embodiments, they can be applied to a soil or soilless substrates (i.e., Coco coir, peat, etc.), in which case the soil or soilless substrate absorbs water and mineral nutrients and serves as a reservoir for these substances. In other embodiments, they can also be supplied in a hydroponic system, which provides constant direct access to water and mineral nutrients by flooding, misting, dripping, wicking, or direct submersion of roots. Plant roots can either grow directly in solution, or into a substrate. If the plant is grown hydroponically in a substrate, it is referred to as “media based hydroponics.” It is typically classified as soilless production if the substrate has a high cation exchange capacity (and anion exchange capacity) and media based hydroponics when the substrate has little or no cation/anion exchange capacity. Examples of hydroponic substrates include, but are not limited to, coconut fiber, vermiculite, perlite, expanded clay pellets, and rockwool (stone wool).

Light treatment, either sun or artificial illumination may have an intensity and duration sufficient for prolonged high rates of photosynthesis throughout the growing season. Suitable illumination intensities lie between 400 and 2000 μmol/m²/s photosynthetically active radiation (400-700 nm), with direct sunlight normally providing sufficient illumination.

Artificial illumination may be obtained for instance by using LED or sodium and/or mercury lamp.

A heat treatment may be applied to the plant for optimal growth, usually at a temperature comprised from 10° C. to 35° C. or higher.

As previously expressed, the flower development notably encompasses the number of flower, the number of open flower produced by the plants, their sizes and/or quality, leading to an enhanced flower yield.

Flower development according to the present invention may be considered as at least in increase of 5% of the number of flowers produced by the plant, preferably from 10% to 80%, preferably from 15 to 50%, compared with untreated plant. This may be calculated per plant, per lot or per m 2 for instance. Flower size may encompass weight, length, area, diameter, circumference or volume of a flower.

In preferred embodiments, the increase in flower production is a net increase of at least 5%, 10%, 20%, 30%, 40%, 50%, 75%, 85%, 95%, 100%, 150%, 200% in flower production, corresponding to the number of flower per crop plant, weight of flower per crop plant, or total yield of flower per crop plant, as compared to the respective values of untreated control plants.

Flower production is generally expressed in: total kilograms of flower per crop plant, average kilogram per flower per crop plant, total number of flower per crop plant, and average number of flower per crop plant.

The present invention also relates to a method of preserving cut flowers, the method comprising: inserting cut stein ends of one or more flowers into a preservative container, optionally comprising a preservative liquid, comprising at least a film comprising at least a matrix and a silicate S1. The invention also refers to a preservative container comprising at least a film comprising at least a matrix and a silicate S1.

The invention refers also then to a method of preserving cut flowers, the method comprising: inserting cut stein ends of one or more flowers into a preservative container, optionally comprising a preservative liquid, comprising at least a film, wherein the film comprises at least a matrix and a silicate S1, preferably dispersed particles of silicate S1, said silicate S1 exhibiting:
(a) a light emission with a first peak wavelength in the range from 400 nm to 500 nm, preferably from 420 nm to 455 nm, and a second peak wavelength in the range from 550 nm to 700 nm, preferably from 590 nm to 660 nm, and
(b) an absorption inferior or equal to 20%, preferably inferior or equal to 15%, more preferably inferior or equal to 10%, possibly inferior or equal to 5%, at a wavelength greater than 440 nm.

The invention also refers to a preservative container, notably for preserving cut flowers, comprising at least a film comprising at least a matrix and a silicate S1, preferably dispersed particles of silicate S1, said silicate S1 exhibiting:
(a) a light emission with a first peak wavelength in the range from 400 nm to 500 nm, preferably from 420 nm to 455 nm, and a second peak wavelength in the range from 550 nm to 700 nm, preferably from 590 nm to 660 nm, and
(b) an absorption inferior or equal to 20%, preferably inferior or equal to 15%, more preferably inferior or equal to 10%, possibly inferior or equal to 5%, at a wavelength greater than 440 nm.

Indeed the film used according to the invention may also permit to preserve the freshness of cut or rooted flowers by containing the cut ends or roots, stems/leaves, and/or blossoms. This may notably allow better plant and cut flower preservation and can allow longer enjoyment of flowers by customers after transport, regional wholesaling, and retail display by the florist.

Such a sealable container comprises a film as used in the invention, preferably with a shape conforming to the shape of the packaged bunch of flowers, such as, the substantially conical shape of many flowers bouquets. The sealable container may also comprise liquid and/or gas exchange perforations that allow gasses to migrate in and/or out for gas exchange with the external environment.

### EXPERIMENTAL PART

The invention will now be further illustrated by the following non limiting examples.

### Example 1: synthesis of Ba_{2.7}Eu_{0.3}Mg_{0.9}Mn_{0.1}Si₂O₈

Particles of Ba_{2.7}Eu_{0.3}Mg_{0.9}Mn_{0.1}Si₂O₈ (P1) are synthetized according to the process as follows:

An aqueous solution was made up from a mixture of barium, magnesium, europium and manganese nitrates with the following composition:

| | | |
|---|---|---|
| Ba(NO₃)₂ | 113.51 | g |
| Mg(NO₃)₃•6H₂O | 37.11 | g |
| Mn(NO₃)₂•4H₂O | 4.00 | g |
| Eu(NO₃)₃ | 40.44 | g |

Water was added to this nitrate mixture to reach a final cationic concentration of 0.27 mol/l. A fumed silica (specific surface: 50 m²/g) suspension was also prepared with a S1 concentration of 0.71 mol/l. The nitrate solution and the suspension of fumed silica were mixed to obtain a global suspension.

The suspension was dried in a flash spray dryer with and input temperature of 350° C. and an output temperature of 140° C. The dried product was calcined at 900° C. for 6 hours under air and then at 1200° C. for 6 hours under Ar/H₂ (95/5) atmosphere.

The particles have a size D₅₀ of 5.2 μm.

These particles exhibit:
(a) a light emission with a first peak wavelength of 438 nm and a second peak wavelength in the range of 620 nm, and
(b) an absorption inferior to 10% at a wavelength greater than 440 nm.

### Example 2: synthesis of Ba_{2.94}Eu_{0.06}Mg_{0.95}Mn_{0.05}Si₂O₈

Particles of Ba_{2.94}Eu_{0.06}Mg_{0.95}Mn_{0.05}Si₂O₈ (P2) are synthetized according to the process as follows:

A solution was made up from a mixture of barium, magnesium, europium and manganese nitrates with the following composition:

| | | |
|---|---|---|
| Ba(NO₃)₂ | 124.60 | g |
| Mg(NO₃)₃•6H₂O | 39.49 | g |
| Mn(NO₃)₂•4H₂O | 2.01 | g |
| Eu(NO₃)₃ | 8.15 | g |

Water was added to this nitrate mixture to reach a final cationic concentration of 0.27 mol/l. A fumed silica (specific surface: 50 m²/g) suspension was also prepared with a S1 concentration of 0.71 mol/l. The nitrate solution and the suspension of fumed silica were mixed to obtain a global suspension.

The suspension was dried in a flash spray dryer with and input temperature of 350° C. and an output temperature of 140° C. The dried product was calcined at 900° C. for 6 hours under air and then at 1200° C. for 6 hours under Ar/H₂ (95/5) atmosphere.

The particles have a size D₅₀ of 5.2 μm.

These particles exhibit:
(a) a light emission with a first peak wavelength of 438 nm and a second peak wavelength in the range of 620 nm, and
(b) an absorption inferior to 10% at a wavelength greater than 440 nm.

### Example 3: Production of Polymer Film

This example illustrates the use of particles of Examples 1 and 2 in a polymer film, to produce film 1 and film 2 respectively.

A masterbatch MB1 comprising 90% by weight of an ethylene/vinyl acetate copolymer (Elvax® 150, commercially available from DuPont) and 10% by weight of silicate was prepared using a co-rotating twin-screw extruder type Prism 25D (diameter 16 mm and L/D ratio of 25, screw profile 25.5)

Pellets of the ethylene/vinyl acetate copolymer and silicate S1 were premixed in a rotary mixer for 10 min and then introduced into the extruder under the following conditions:

| | |
|---|---|
| Raw material flow rate (kg/h) | 1.8 |
| Screw rotation speed (rpm) | 250 |
| Temperature (° C.) | 90 |

A masterbatch MB1 was thus obtained in the form of pellets.

To get film 1, 402 g of MB1 were mixed with 7650 g of pure ethylene/vinyl acetate copolymer (representing in the final composition a silicate loading of 0.5% by weight) during 10 minutes in a rotative blender then extruded using a co-rotating twin-screw extruder Leistritz LMM 30/34 type (34 mm diameter and L/D ratio of 25, screw profile: L16 without degassing) equipped with a slot die (300 mm in width and 450 to 500 microns thick). Extrusion parameters are reported in the following table:

| | |
|---|---|
| Raw material flow (kg/h) | 3 |
| Screw rotation speed (rpm) | 200 |
| Extrusion temperature (° C.) | 90 |
| Chill roll temperature (° C.) | 10 |
| Film output speed (m/min) | 0.5 |
| Film tension (N) | 6 |

A similar film was prepared to get film 2 by mixing 1206 g of MB1 with 6848 g of pure ethylene/vinyl acetate copolymer (representing in the final composition a silicate loading of 1.5% by weight).

The obtained had a thickness of 450 μm in average.

The film 1 has a transmission of 90.6% and film 2 a transmission of 85.7% (measured with a Gardner Haze-gard i (4775) Haze Meter from BYK, according to the standard method ASTM D1003).

The film 1 obtained emits a crimson color when it is subjected to illumination at a wavelength of 365 nm.

The film 2 obtained emits a crimson color when it is subjected to illumination at a wavelength of 365 nm.

Also a film 0 without any particles is produced. The film 0 obtained does not emit any color when it is subjected to illumination at a wavelength of 365 nm.

### Example 4: Agronomic Tests

Evaluation of the agronomic behavior of a tomato crop has been made under plastic roof in greenhouse with the use of films 1, 2 and 3.

These trials have been carried out in a special greenhouse of 20 m 2 of total area. This greenhouse has been divided in five different cages and a different film plastic cover has been installed in the roof of each cage. This greenhouse has been provided with an active climatic control system with a cooling system which has been controlled by an automated system, where the set point temperature and the cooling activation has been set at 26° C. The tomato crop has been grown in substrate, in coconut fibber bags. The irrigation and fertilization of the tomato crop has been carried out through the use of a drip irrigation system, with paired rows of dripper lines located at each plant, and with the emitters within the same dropper-holder branch located every 50 cm. The installation of drip irrigation has had self-compensating drippers with a unit flow of 3 liters/hour/dripper. The fertigation system used during this trial has been controlled automatically with an irrigation unit provided with a programmer and one tank of concentrated nutrient solution.

The field trial has been developed during a cropping cycle of winter-spring tomato (five months long). The tomato crop (Solanum lycopersicum variety “Trujillo”), has been transplanted in the greenhouse, with more than 20 days old since its germination in the nursery and with three leaves completely developed.

The plant density used has been 6 plants by m². During this trial, the tomato crop has been guided using black polypropylene cords vertically joined to the wire structure of the greenhouse. The total duration of the tomato cropping cycle has been 131 days.

The installation of 3 different plastic films has been carried out inside the greenhouse before the transplanting of the tomato crop. Different plastic films have been installed in the roof of each cage, so that each cage of the greenhouse has been a different experimental treatment. There have been six plants per experimental treatment (cage). The experimental treatments evaluated have been distributed inside the greenhouse following a distribution of blocks.

During all the trial period, the air temperature has been controlled continuously using a cooling system which exceeding the set point temperature of 26° C., the cooling system has been activated by emitting air from the outside to the inside of the treatments, thus allowing a renewal of the air and decreasing the air temperature.

Different parameters have been measured at seven different moments during the development of the tomato crop.

In each measurement, six tomato plants of each treatment have been evaluated. The parameter measured has been: basal diameter of the stein, length of the plant, number of developed leaves, number of opened flowers. The number of opened flowers has been counted every two weeks during four consecutive months. The pollination of the flowers has been carried out by means of a manual system of flower vibration.

The yield harvested in each episode of harvesting (during 4 harvesting episodes) has been characterized by measuring the number of flowers in each experimental treatment. This characterization has been carried out in each plant of a group of six plants per experimental treatment.

Results are reported in the Table 1 as follows:

TABLE 1

| PARAMETERS | DAYS | Film 0 | Film 1 | Film 2 |
|---|---|---|---|---|
| Height evolution (cm/plant) | 7 | 36.3 | 36.2 | 36.7 |
| | 32 | 75.0 | 80.0 | 79.2 |
| | 45 | 113.5 | 119.8 | 119.3 |
| | 74 | 210.8 | 208.2 | 209.8 |
| Basal diameter evolution | 7 | 0.43 | 0.5 | 0.4 |
| (cm/plant) | 32 | 0.6 | 0.6 | 0.6 |
| | 61 | 0.88 | 0.98 | 0.96 |
| | 88 | 1.12 | 1.07 | 1.14 |
| Number of leaves evolution | 7 | 5.3 | 5.5 | 5.9 |
| (#/plant) | 32 | 11.2 | 11.8 | 11.3 |
| | 74 | 15.6 | 17.0 | 16.8 |
| | 88 | 16.8 | 18.0 | 19.6 |
| Developed flower evolution | 12 | 0.5 | 0.8 | 0.7 |
| (#/plant) | | | | |
| #flowers obtained from | — | 12.80 | nm | 15.55 |
| day 74 to 131/plant | | | | |
| Onset (#days necessary to | — | 55 | 45 | nm |
| obtain 4 flowers/plant) | | | | |
| Resistance (#opened flowers/ | — | 3.8 | 4.0 | 4.0 |
| plant at 88 days) | | | | |

nm—non measured

It appears then that the use of specific silicates in a greenhouse film according to the invention permits to increase the flower development of a plant, in comparison with a film that does not comprise any silicate.

1. A film comprising at least a matrix and a silicate S1 for increasing flower development of a plant, the silicate S1 exhibiting:
(a) a light emission with a first peak wavelength in the range from 400 nm to 500 nm, and
(b) an absorption inferior or equal to 20% at a wavelength greater than 440 nm.

2. The film according to claim 1, wherein the silicate S1 is a compound of formula (I):
aMO·a′M′O·bM″O·b′M″O·cSiO₂ (I)
wherein M and M″ are selected from the group consisting of strontium, barium, calcium, zinc, magnesium and combinations thereof, and M′ and M′″ are selected from the group consisting of europium, manganese, praseodymium, gadolinium, and yttrium, with 0.5<a≤3, 0.5<b≤3, 0<a′≤0.5, 0<b′≤0.5 and 1≤c≤2.

3. The film according to claim 1, wherein the silicate S1 is a compound of formula (II):
aBaO·xEuO·cMgO·yMnO·eSiO₂ (II)
wherein 0<a≤3, 0<x≤0.5, 0<c≤1, 0<y≤0.5, 0<e≤2.

4. The film according to claim 3, wherein 0.0001≤x≤0.4 and 0.0001≤y≤0.4.

5. The film according to claim 3, wherein 0.01<x≤0.35 and 0.04≤y≤0.15.

6. The film according to claim 1, wherein in formula (II) the barium, the magnesium and the silicon are not substituted with an element other than europium and manganese.

7. The film according to claim 3, wherein the compound of formula (II) is Ba_{2.7}Eu_{0.3}Mg_{0.9}Mn_{0.1}Si₂O₈.

8. The film according to claim 3, wherein the compound of formula (II) is Ba_{2.94}Eu_{0.06}Mg_{0.95}Mn_{0.05}Si₂O₈.

9. The film according to claim 1 wherein the silicate S1 is a compound of formula (III):
Ba_{3(1-x-y)}Eu₃ₓPr_{3y}Mg_{1-z}Mn_{z}Si_{2(1-3v/2)}M₃ᵥO₈ (III)
wherein M represents aluminum, gallium or boron and 0<x≤0.3; 0<y≤0,1; 0<z≤0.3; 0≤g≤0.1.

10. The film according to claim 1, wherein the amount of silicate S1 in the film is from 0.01 to 10% by weight, with respect to a total amount of film.

11. The film according to claim 1, wherein the silicate S1 is in the form of solid particles having a size D50 between 1 μm and 50 μm.

12. The film according to claim 1, wherein the silicate S1 is in the form of solid particles having a size D50 between 0.1 μm and 1.0 μm.

13. The film according to claim 1, wherein the matrix comprises at least one polymer or wherein the matrix is a polymer.

14. The film according to claim 13, wherein the matrix is based on a polymer selected from the group consisting of polyethylenes and copolymers, including low-density polyethylenes (LDPE), linear low-density polyethylenes (LLDPE), high density polyethylene (HDPE), polyethylenes obtained via metallocene synthesis, ethyl vinylacetate copolymer (EVA), ethylene butyl acrylate copolymer (EBA), polyvinyl chloride (PVC), polyethylene terephthalate (PET), polymethyl methacrylate (PMMA), (co)polyolefins, polyethylene-vinyl alcohol (EVOH), polycarbonate (PC), and mixtures and copolymers based on these (co)polymers.

15. The film according to claim 1, wherein the plant is selected from the group consisting of tomatoes, watermelons, peppers, zucchinis, cucumbers, melons, strawberries, blueberries, raspberries and roses.

16. (canceled)

17. (canceled)

18. A method for increasing the flower development of a plant in which the flower development is stimulated by a light emission provided by a greenhouse film;
said film comprising at least a matrix and a silicate S1, said silicate S1 exhibiting:
(a) a light emission with a first peak wavelength in the range from 400 nm to 500 nm, and
(b) an absorption inferior or equal to 20% at a wavelength greater than 440 nm.

19. A method for increasing the flower development of a plant in which the plant is in a greenhouse comprising a greenhouse film; said film comprising at least a matrix and a silicate S1, said silicate S1 exhibiting:
(a) a light emission with a first peak wavelength in the range from 400 nm to 500 nm, and
(b) an absorption inferior or equal to 20% at a wavelength greater than 440 nm.

20. A method of preserving cut flowers, the method comprising: inserting cut stem ends of one or more flowers into a preservative container, optionally comprising a preservative liquid, comprising at least a film, wherein the film comprises at least a matrix and a silicate S1 exhibiting:
(a) a light emission with a first peak wavelength in the range from 400 nm to 500 nm, and
(b) an absorption inferior or equal to 20% at a wavelength greater than 440 nm.

21. A preservative container comprising at least a film comprising at least a matrix and a silicate S1 exhibiting:
(a) a light emission with a first peak wavelength in the range from 400 nm to 500 nm, and
(b) an absorption inferior or equal to 20% at a wavelength greater than 440 nm.
